(19) United States
(12) Patent Application Publication
(10) Pub. No.: US 2002/0062722 A1
(43) Pub. Date: May 30, 2002

(54) Barfield's non-slip spur

(76) Inventor: John William Barfield, Jacksonville, FL (US)

Correspondence Address: John W. Barfield, 12327 Sapp Road, Jacksonville, FL, 32226, US

(21) Appl. No.: 09/726,248

(22) Filed: Nov. 30, 2000

(51) Int. Cl. B23B 25/00; B23B 31/00

(52) U.S. Cl. 82/162; 82/165

(57) ABSTRACT

The “Barfield Non-Slip Spur” has the unique recessed chamber compartment that allows for stock to be inserted into the chamber for holding prior to the turning process. This feature does not allow slippage, boring, or splitting of the stock. Small length stock can be turned without the tail stock center

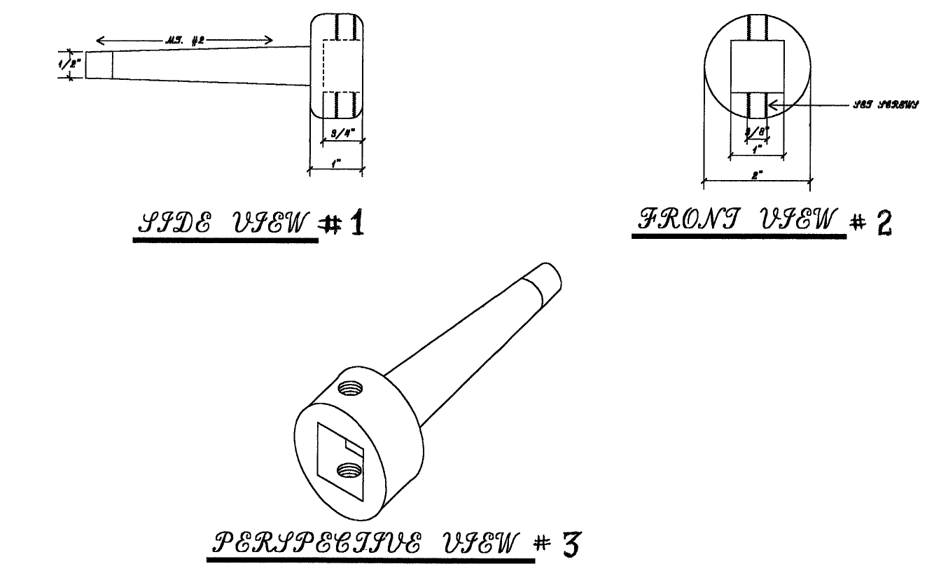

### BACKGROUND OF THE INVENTION

The Field of Specialty that this invention pertains to, is that of Woodwork.

This Applicant/Inventor does not know of the applicable U.S. Patent definition for this particular field that his Invention would be classified under.

This Applicant/Inventor also does not know of any information referencing specific documents that are related to his invention.

Regarding references to specific problems that are involved in the prior state of Technology that are solved by this invention, are:

The existing Spur was designed to hold a stock by securing one end of the stock onto the tapered cross sections of the Spur. This method has been an age old problem in that while the stock is being turned, the Spur will slip from its notched insertion at the stocks end and lose the grip that is needed to turn the stock. Or, the Spur will actually bone into the stock end and will actually split smaller stock.

### BRIEF SUMMARY OF THE INVENTION

The Barfield Non-Slip Spur by design has one main functional advantage over the existing present Spurs on the market today.

1. The new non-slip Spur will not allow the stock to slip, bore-out or split.

2. The prevention of these existing problems are solved through the new non-slip feature of a recessed chamber that will retail the stock's protruding tongue which would be cut to fit the squared chamber.

3. Set-up time in preparing to turn the stock is greatly reduced as well as time saved in having to re-aline the stock due to slippage, boring or splitting, which is totally eliminated through the non-slips recessed chamber feature.

The object of the non-slip Spur is to increase productivity by reducing set-up time and stock waste.

### BRIEF DESCRIPTION OF THE SEVERAL VIEWS OF THE DRAWING

View 1 (Side View)

This view depicts the side-view of a typical Spur with the new Barfield non-slip recessed chamber. This view illustrates the mortis taper that fits into the power-end of the lathe that coyers in sizes of two & three, the chamber depth will be three fourths (¾) inch deep squared.

View II (Front View)

The front view illustrates the opening of the chamber that will allow the stock to be inserted and seated. The stock, once inserted would be held in place by ⅜ lock nuts or the tail stock center.

View III (Perspective View)

The perspective view illustrates the actual simulation of the Barfield's non-slip Spur.

### DETAILED DESCRIPTION OF THE INVENTION

The Barfield non-slip Spur is an improvement feature to the existing conventional Spur.

The Conventional Spur's Mortis taper body and head remain unchanged, except the Spur's tapered protcustive Cross-head will be redesigned into a recessed chamber that allows the stock to be seated within the head and secured, instead of the conventional protruding notches seating that is required on the present Spurs.

The recessed chamber will be contained within the Spur Head itseld. Three-eight's lock nuts will be inserted directly into the Spur Head Body allowing the stock to be secured and held in place within the chamber preventing slippage. The old Spur got to use the tail stock o hold the stock.

What I claim as my invention is;

1. A conventional Spur that has retained the same Mortis Taper Feature, but has a redesigned Spur Head that Features a “recessed chamber” of ¾ inch in depth by 1 inch in width and height, that allows for the “insertion” of the stock and is secured by ⅜ inch lock nuts.
